(19) United States
(12) Patent Application Publication
(10) Pub. No.: US 2012/0054023 A1
(43) Pub. Date: Mar. 1, 2012

(54) Delivering Highly Targeted Advertisements Based on a Credit System

(76) Inventor: Yang Pan, Singapore (SG)

(21) Appl. No.: 12/868,616

(22) Filed: Aug. 25, 2010

(51) Int. Cl. G06Q 30/00

(52) U.S. Cl. 705/14.45; 705/14.55

(57) ABSTRACT

A method of monitoring effectiveness of an advertisement delivered to a user of an electronic system is disclosed. An alerting message for notifying the user to accumulate a credit is delivered randomly during an event of streaming of a program of the advertisement. The message may be displayed as a visual image or a video program in a predetermined position of a display. A user may actuate a predetermined input structure when the alerting message is notified. A credit is then assigned to the user. A personalized file recording a history of the user's reaction to the advertised messages is employed to deliver highly targeted advertisements to the user in a late stage.

### CROSS-REFERENCE TO RELATED APPLICATIONS

Not applicable.

### BACKGROUND

1. Field of Invention

This invention relates generally to advertising. More specifically, the invention relates to methods for delivering highly targeted advertisement to a user of an electronic system.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to provide a method to evaluate the effectiveness of an event of delivering an advertisement to a user of an electronic system.

It is a further object of the present invention to provide a method of delivering a highly targeted advertisement based on a history of the user's reaction to an alerting message displayed during streaming of a program of the advertisement.

According to one embodiment of the present invention, an advertisement delivery system comprises a digital television system, a data manager and a communication network for connecting them. The digital TV system further comprises a display screen and a remote control device including an input structure. When an advertisement is broadcasted, an alerting message such as, for example, a visual image is displayed in a predetermined position of the screen. The alerting message may be displayed in accompanying with a sound according to one implementation. The user may actuate the input structure after notifying the message. A credit is then assigned to the user. In case that the user missed the action to actuate the input structure within a predetermined period of time, no credit will be assigned to the user.

A personalized file including a hierarchical categorization of advertisements may be stored in a data manager connectable to the digital TV through a communication network. The data manager updates the personalized file when each time new credit points are added to a category of advertisement. Targeted advertisements are delivered to the user based on the personalized file in a late stage.

According to other embodiments, the electronic system may be a computer, a mobile computing and communication device and a media delivery system. The advertisements may be delivered as a video program, a web page, a texted message, a voice message and a multi-media message.

According to other implementations, the alerting messages may be delivered as a web site, a texted message, a voice message and a multimedia message. The alerting message may be delivered in a display window within a display screen.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary advertisement delivery system;

FIG. 2 is a schematic diagram illustrating functional blocks in an electronic system and in a data manager;

FIG. 3 is a schematic diagram illustrating that an alerting message is displayed on a display of a digital TV system when an advertisement is broadcasted;

FIG. 4 is a schematic diagram illustrating an exemplary data structure of a personalized file including categories of advertisements and credit points for each category and each sub-category;

FIG. 5 is a flowchart illustrating an exemplary process that a credit is assigned to a user if a predetermined input structure is actuated after the user views an alerting message during broadcasting an advertisement;

FIG. 6 is a flowchart illustrating an exemplary process that a targeted advertisement is delivered based on the updated personalized file;

FIG. 7 is a flowchart illustrating an exemplary process that personalized file may be updated based on credits collected from a number of electronic systems connectable to the data manager.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

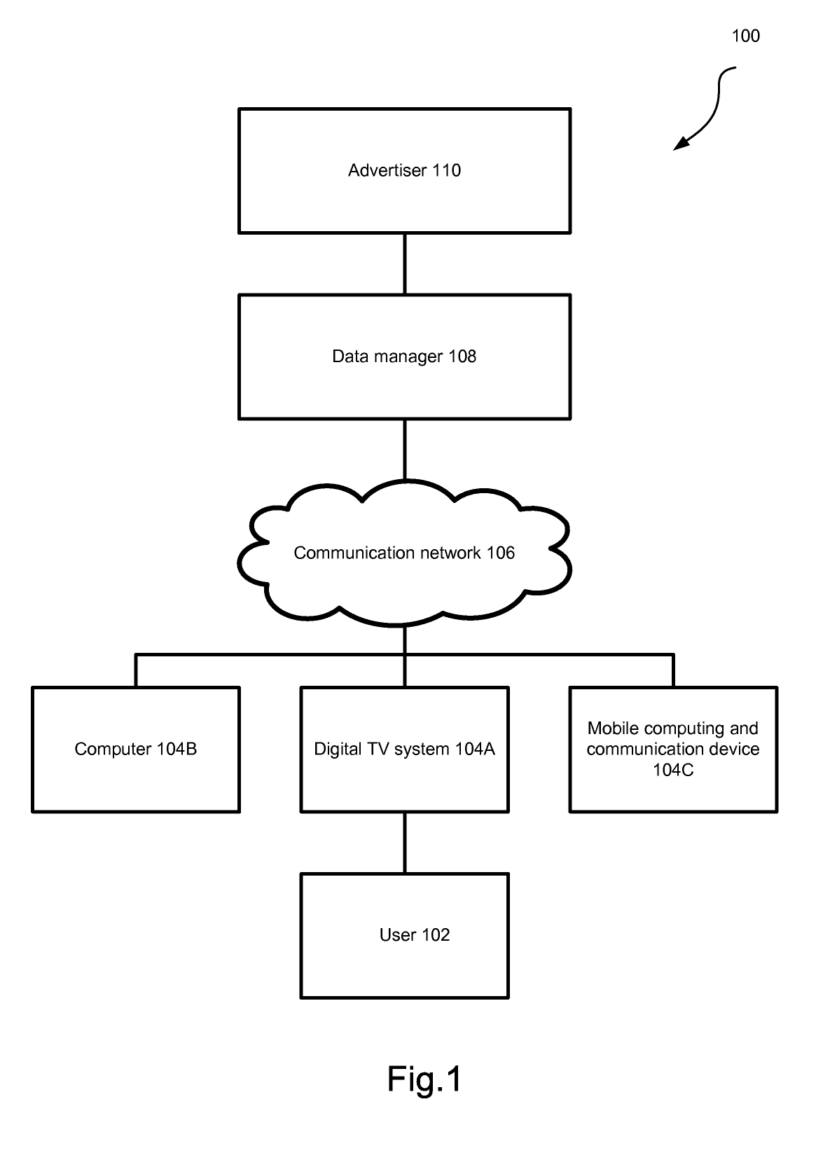

FIG. 1 is a schematic diagram of an exemplary advertisement delivery system for delivering advertisements based on a credit system. The exemplary system 100 comprises a user 102 and a number of electronic systems including a digital TV system 104A, a computer 104B and a mobile computing and communication device 104C. The mobile computing and communication device may be a smart phone. The electronic systems 104 are connectable to a data manager 108 through a communication network 106. The data manager 108 may be a server operated by an advertiser 110. The communication network 106 may be a digital TV distribution network. The network 106 may also be the Internet or a public phone network. The network 106 may even be a combination of multiple networks as mentioned.

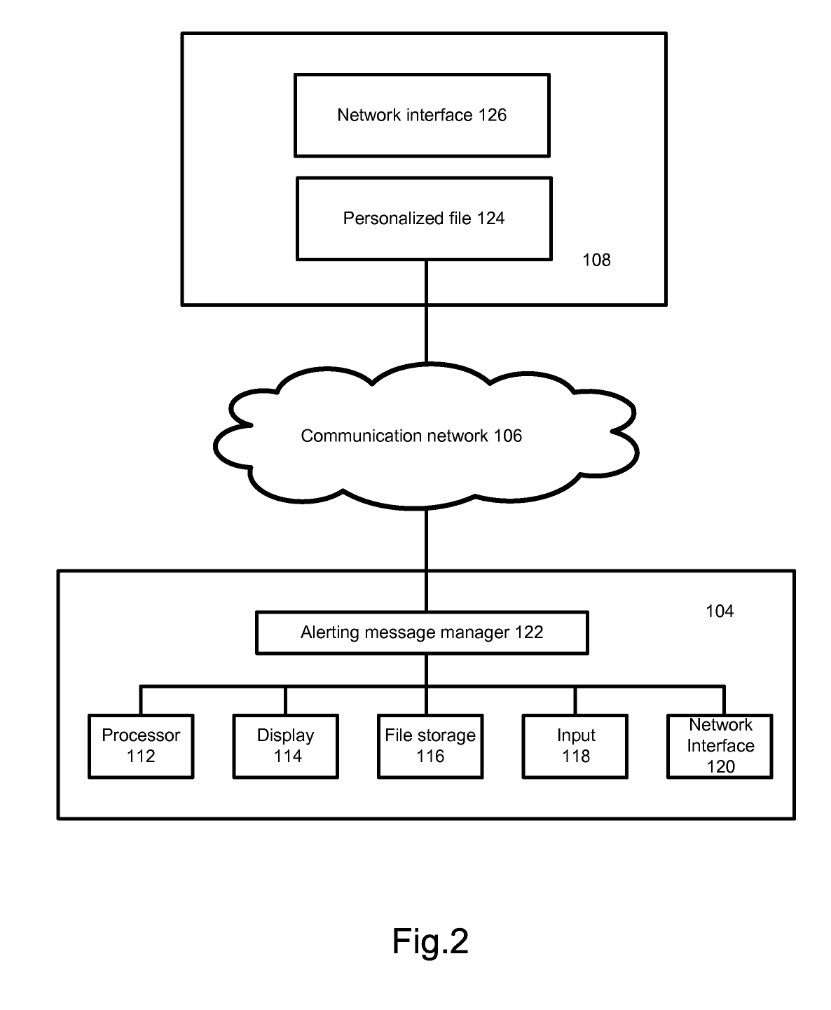

FIG. 2 is a schematic diagram of functional blocks of the electronic system 104 and the data manager 108. The exemplary electronic system further includes a processor 112. The processor 112 may include a general purpose data processor such as, for example, a Central-Processing-Unit (CPU) and special purpose data processors. The electronic system 104 may further include a display 114. The display 114 may be a Liquid-Crystal-Display (LCD) according to one implementation. The electronic system 104 may include a file storage unit 116. The file storage unit 116 may include a mass storage device such as one or a plurality of magnetic storage devices. The storage unit 116 may also include one or a plurality of semiconductor flash memories. The file storage unit 116 may further include a Random-Access-Memory such as SRAM's for reducing access time. The electronic system 104 includes an input unit 118. The input unit 118 may be a remote control device for a digital TV system. The input unit 118 may also be a keyboard or a mouse for a computer. The input unit 118 may also be a touchpad. The input unit 118 may even be a touch-sensitive display for a mobile computing and communication device. A network interface 120 is used to connect the electronic system 104 to a communication network 106.

The electronic system 104 is further characterized by an alerting message manager 122. When an advertisement is streamed by the electronic system 104, an alerting message is delivered to the user by the alerting message manager 122. The alerting message may be delivered in a randomly determined time during broadcasting of the advertisement. After the user 102 notifies the alerting message, he may actuate a predetermined input structure. Credit points will then be assigned to the user 112.

The data manager 108 may be a server comprising a personalized file 124 and a network interface 126. The personalized file 124 may include categories and sub-categories of advertisements. Each category and each sub-category are associated with a counter of credit points reflecting the user's history of viewing advertisements. It should be noted that the data manager 108 may be connectable to multiple electronic systems. The user's interaction with each of the systems during the broadcasting of the advertisements may be used to update the personalized file 124. Therefore, highly targeted advertisements may be delivered to any one of the electronic systems based on the personalized file in a later stage. The network interface 126 is used to connect the data manager 124 to the communication network 106.

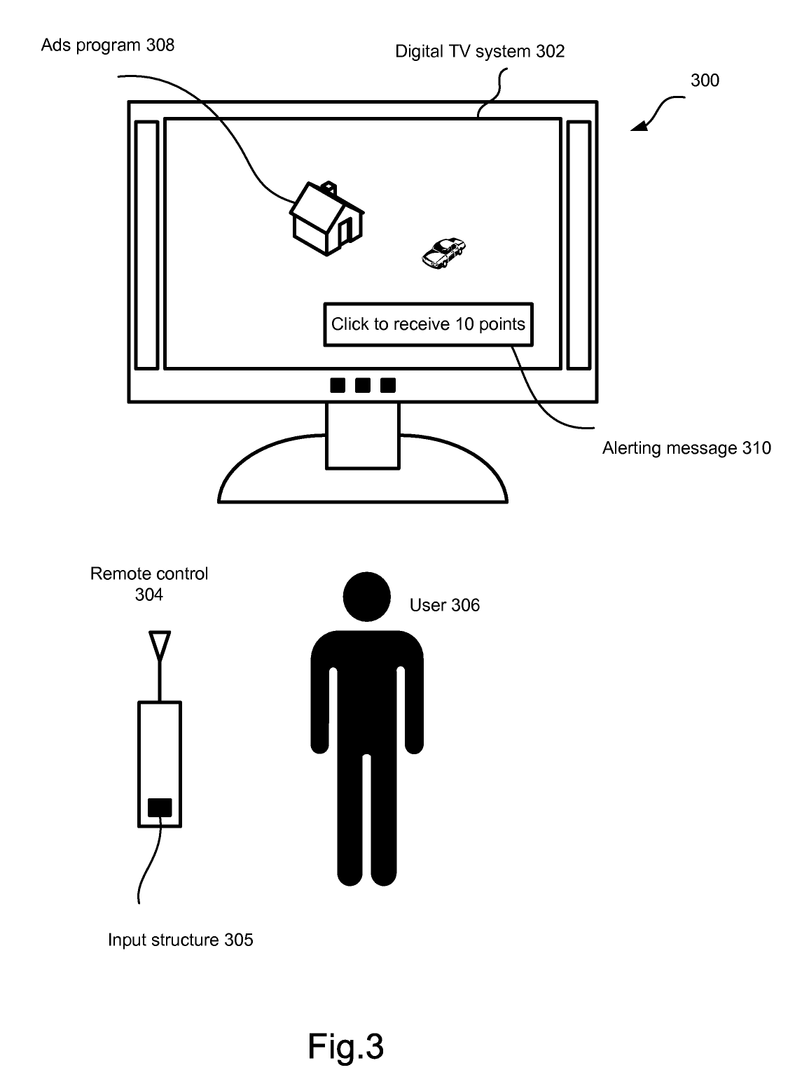

FIG. 3 is an exemplary illustration of one embodiment 300 of the present invention. A digital TV system 302 is used to illustrate the inventive concept without limiting the scope of the invention. The digital TV system 302 includes a remote control device 304. The remote control device 304 further includes an input structure 305. The user 306 operates the system. When an advertisement program 308 is broadcasted by the digital TV system 302, an alerting message 310 may be displayed in a predetermined position of the screen in a randomly determined time. The alerting message 310 may be displayed as a texted message as shown in the FIG. 3. The alerting message 310 may also be delivered as a video program. The alerting message may be displayed as one or multiple images. The alerting message 310 may be delivered with animations. The alerting message 310 may be delivered in accompanying of a sound to attract the user's attention.

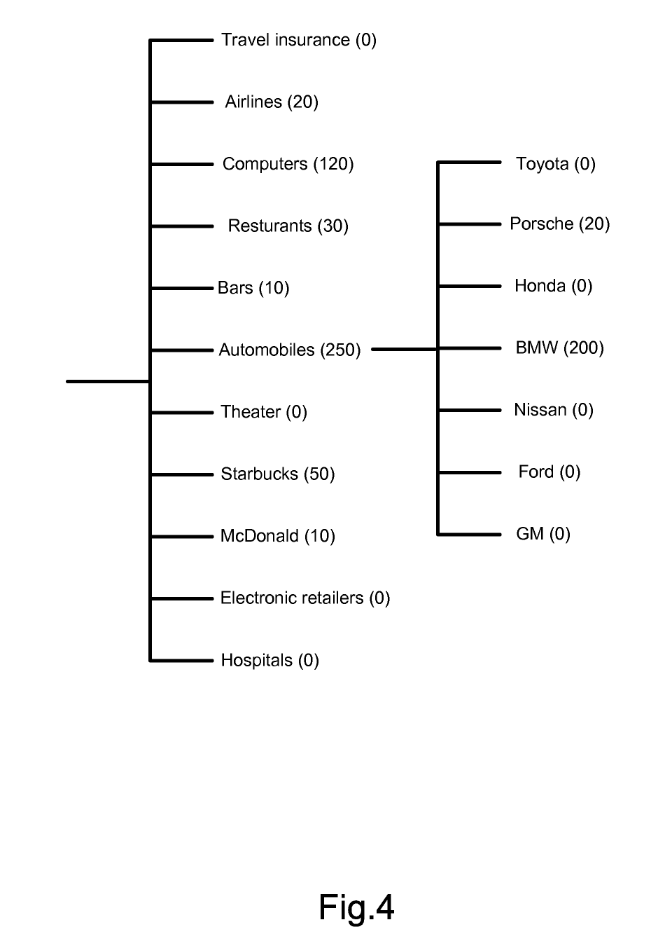

FIG. 4 is a schematic diagram illustrating an exemplary data structure of the personalized file. Each category and each sub-category of advertisements are assigned with a counter for credit points. After the user reacts to the alerting message during broadcasting of an advertisement program, the related counters are updated. In the exemplary case illustrated in FIG. 4, the user is clearly interested in automobiles and in particularly in BMW cars. The user may be planning to purchase a luxury car and may be interested in BMW. The advertisements and promotional messages related to the BMW cars may be delivered to the user through a number of electronic systems used by the user. The user may also receive other luxury car advertisements.

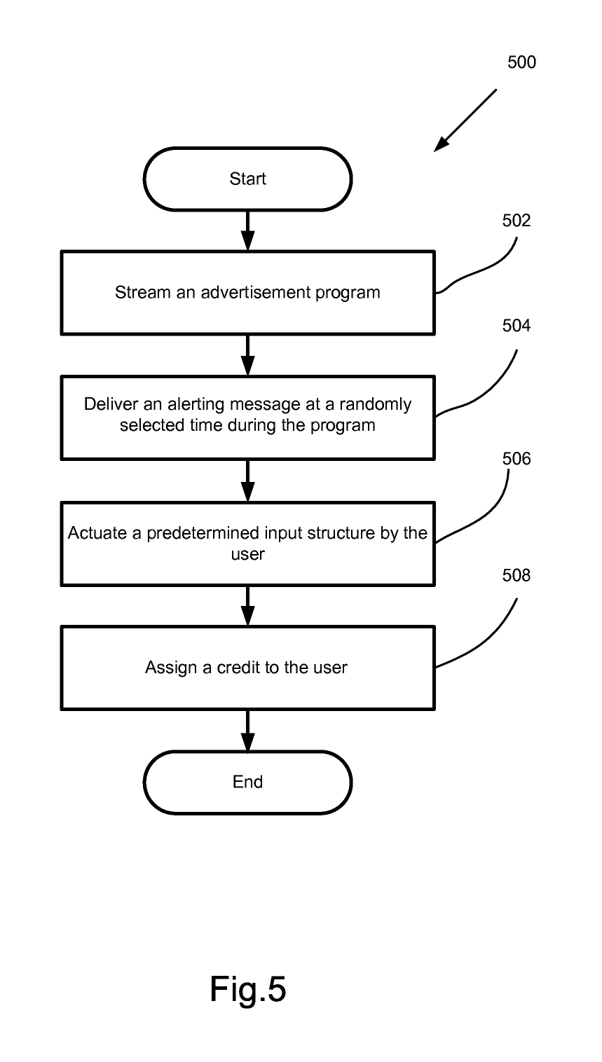

FIG. 5 is a flowchart illustrating an exemplary process that credit points are assigned to a user if a predetermined input structure is actuated after viewing an alerting message during broadcasting an advertisement. Process 500 starts with step 502 that an advertisement program is broadcasted by an electronic system 104 such as, for example, a digital TV system. An alerting message is displayed at a randomly selected time during the program in step 504. The user may actuate a predetermined input structure of a predetermined input unit of the electronic system 104 in step 506. For example, the user may actuate the input structure 305 of the remote control device 304. A predetermined number of credit points may be assigned to the user in step 508. The credit points may be taken to update related counters in the personalized file 124 in the data manager 108.

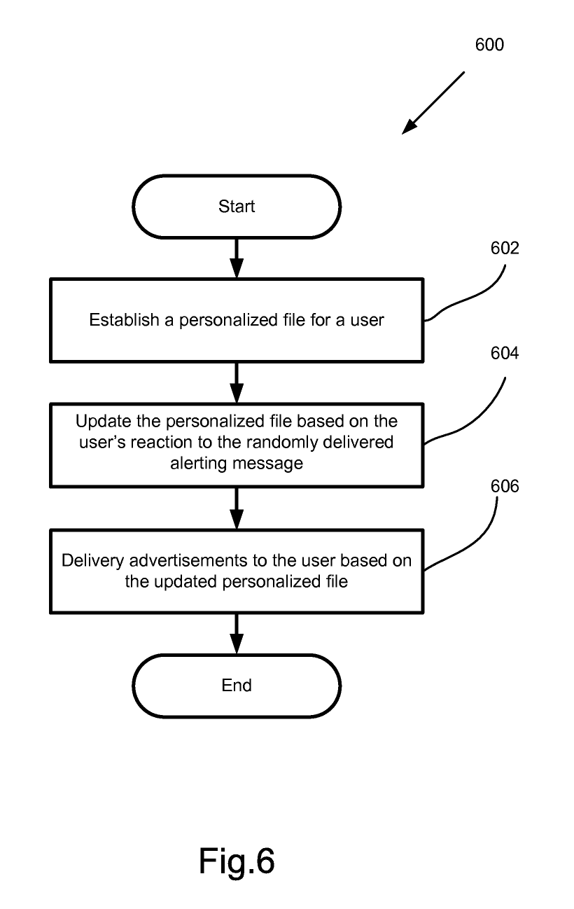

FIG. 6 is a flowchart illustrating an exemplary process that a targeted advertisement is delivered based on the personalized file. Process 600 starts with step 602 that a personalized file for a user is established in the data manager 108. The file is updated in step 604 when each time the user reacts to the randomly delivered alerting message. The points for each category and each sub-category of advertisements may be updated. Highly targeted advertisements may be delivered to the user in step 606 based on the updated personalized file 124.

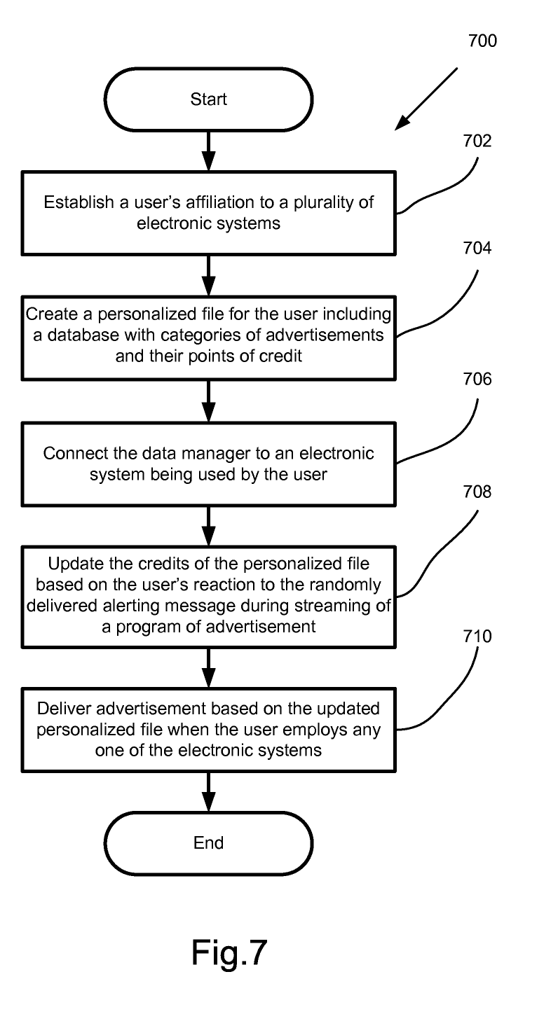

FIG. 7 is a flowchart illustrating an exemplary process that personalized file may be updated based on credits collected from a number of electronic systems connectable to the data manager. Process 700 starts with step 702 that a user's affiliation to a number of electronic systems is determined. Each of electronic systems may have an identity. The identity may be associated to one or multiple users. A personalized file is created in step 704. The file may include category and sub-category of advertisements. Each of them may be associated with a counter of credit points which reflects the user's interest level in the category or the sub-category. When a user starts to use an electronic system 104, the data manager 108 and the electronic system 104 are connected through the communication network 106 in step 706. The communication network 106 may be a broadband communication network for digital TV. The communication network 106 may also be the Internet. The personalized file 124 may be updated in step 708 to reflect the user's interaction with the electronic system during broadcasting the advertisement program. Highly targeted advertisements may be delivered to the user when any one of the electronic systems affiliated with the user is employed in a late stage. In case that an electronic system may be used by multiple users, the user's identity may be determined either through a login-in process or through an identification process employing biometric data of the user.

1. A method of evaluating effectiveness of an event of delivering an advertisement to a user of an electronic system comprising:
a. streaming a program of an advertisement;
b. delivering an alerting message in a randomly determined time during the program; and
c. assigning a credit to the user if a predetermined input action upon an input structure from the user is received.

2. The method as recited in claim 1, wherein said method further comprising determining identity of the user.

3. The method as recited in claim 1, wherein said method further comprising establishing a personalized file for the user, wherein said personalized file further comprising a database including the user's accumulated credits for a plurality of categories of advertisements.

4. The method as recited in claim 3, wherein the method further comprising delivering advertisements to the user in a future time based on the personalized file.

5. The method as recited in claim 1, wherein said electronic system further comprising a display and said alerting message is delivered as a visual image or as a video program in a display window in a predetermined position of the display.

6. The method as recited in claim 5, wherein said visual image or said video program may be delivered in accompanying with a notable sound signal.

7. The method as recited in claim 1, wherein said input structure may be selected from the following group:
a. a button;
b. a key;
c. a touchpad; and
d. an icon in a touch-sensitive screen.

8. The method as recited in claim 1, wherein said electronic systems further comprising:
a. a digital television system;
b. a computer;
c. a mobile computing and communication device; and
d. a media delivery system.

9. A method of delivering a targeted advertisement to a user of electronic system based on a credit system for categories of advertisements comprising:
a. establishing a personalized file including the user's accumulated credits for each category of the advertisement; wherein said credits are established by a method of randomly delivering an alerting message during streaming a program of an advertisement and, consequently, tracking the user's input action upon an predetermined input structure; and
b. delivering advertisements to the user based on the personalized file.

10. The method as recited in claim 9, wherein said method further comprising determining the identity of the user.

11. The method as recited in claim 9, wherein said electronic system further comprising a display and said alerting message is delivered as a visual image or as a video program in a display window in a predetermined position of the display.

12. The method as recited in claim 11, wherein the visual image and video program may be delivered in accompanying with a notable sound.

13. The method as recited in claim 9, wherein said input structure may be selected from the following group:
a. a button;
b. a key;
c. a touchpad; and
d. an icon in a touch-sensitive screen.

14. The method as recited in claim 9, wherein said personalized file may be located in a data manager connectable to the electronic system through a communication network.

15. The method as recited in claim 9, wherein said credits may be established through the user's interaction with a plurality of electronic systems connectable to the data manager.

16. An advertisement delivery system comprising:
a. a plurality of electronic systems connectable to a data manager through a communication network;
b. an alerting message manager in each of the electronic system;
c. a personalized file including accumulated credits for categories of the advertisements; and
d. a means of delivering a targeted advertisement to the user based on the personalized file.

17. The system as recited in claim 16, wherein the electronic system further comprising:
a. a digital television system;
b. a computer;
c. a mobile computing and communication system; and
d. a media delivery system.

18. The system as recited in claim 16, wherein said alerting message manager further comprising a means of accumulating credits for each category of the advertisement; wherein said credits are accumulated by a method of randomly delivering an alerting message during streaming of a program of advertisement and, consequently, tracking the user's input action upon a predetermined input structure.

19. The system as recited in claim 16, wherein said data manager may be operated by an advertiser.

20. The system as recited in claim 16, wherein said communication network may be the Internet and/or a public phone network and/or a broadband television network.
